(19) United States
(12) Patent Application Publication
(10) Pub. No.: US 2017/0091254 A1
(43) Pub. Date: Mar. 30, 2017

(54) MAKING VOLATILE ISOLATION TRANSACTIONS FAILURE-ATOMIC IN NON-VOLATILE MEMORY

(71) Applicant: Kshitij A. Doshi, Chandler, AZ (US)

(72) Inventor: Kshitij A. Doshi, Chandler, AZ (US)

(21) Appl. No.: 14/864,583

(22) Filed: Sep. 24, 2015

(51) Int. Cl. G06F 17/30; G06F 12/08

(52) U.S. Cl. CPC G06F 17/30371; G06F 12/0864; G06F 17/30377; G06F 2212/1016

(57) ABSTRACT

Systems, apparatuses and methods may provide for generating a log of a first transaction that involves a modification of a variable in a volatile memory and activating a controlled deferment of a second transaction associated with the variable. Additionally, an update of data in non-volatile memory may be conducted based on the modification while the controlled deferment is activated. In one example, activating the controlled deferment including initializing a hash value associated with the variable, incrementing the hash value, and storing the incremented hash value to the volatile memory.

### TECHNICAL FIELD

Embodiments generally relate to transaction synchronization. More particularly, embodiments relate to making volatile isolation transactions failure-atomic in non-volatile memory under hardware provided isolation (e.g., using hardware for transactional memory).

### BACKGROUND

Database systems may be accessed via a large number of concurrent transactions. The ability to process database transactions reliably may be characterized in terms of a set of properties referred to as ACID (atomicity, consistency, isolation, durability). Database systems may address the AD (atomicity, durability) portion of the ACID properties by documenting data write operations (“writes”) with log or journal entries that precede (e.g., “cover”) the writes. Thus, if a system failure occurs during a logged transaction, the log entry may be used to either redo the transaction or undo the transaction in order to render the transaction atomic (e.g., indivisible) and durable (e.g., persistent).

Database systems may address the CI (consistency, isolation) portion of the ACID properties by implementing locking, latching, functional decomposition (e.g., different processors perform different tasks to achieve mutual exclusion) or data decomposition (e.g., different processors work on different regions of data to achieve mutual exclusion), wherein AD and CI may be meshed via a lock-log-unlock approach. In such a case, all locks acquired by a transaction may be released only after the log that records all of its changes is in durable store (e.g., non-volatile memory/NVM).

While the conventional approach to achieving ACID in database systems may be suitable in certain circumstances, there remains considerable room for improvement. For example, lock enforcement may result in a substantial amount of processing overhead that may be unnecessary with respect to transactions that do not intersect with one another. Although some solutions may provide lock-free transaction isolation in volatile memory with the aid of hardware enforced automatic transactional exclusion, those solutions may not readily support atomicity and durability with respect to NVM. Accordingly, transactions that conduct input/output (IO) operations, flush cache lines or otherwise write to NVM may still experience substantial lock-related overhead as they may not be able to make use of hardware based transactional exclusion, even when there is no actual data intersection between the transactions.

### BRIEF DESCRIPTION OF THE DRAWINGS

The various advantages of the embodiments will become apparent to one skilled in the art by reading the following specification and appended claims, and by referencing the following drawings, in which:

FIG. 1A is a flowchart of an example of a method of operating a transaction synchronization apparatus according to an embodiment;

FIG. 1B is an illustration of an example of a set of time spans corresponding to the method of FIG. 1A according to an embodiment;

FIG. 2 is a block diagram of an example of a transaction synchronization apparatus according to an embodiment;

FIG. 3 is a block diagram of an example of a processor according to an embodiment; and

FIG. 4 is a block diagram of an example of a system according to an embodiment.

### DESCRIPTION OF EMBODIMENTS

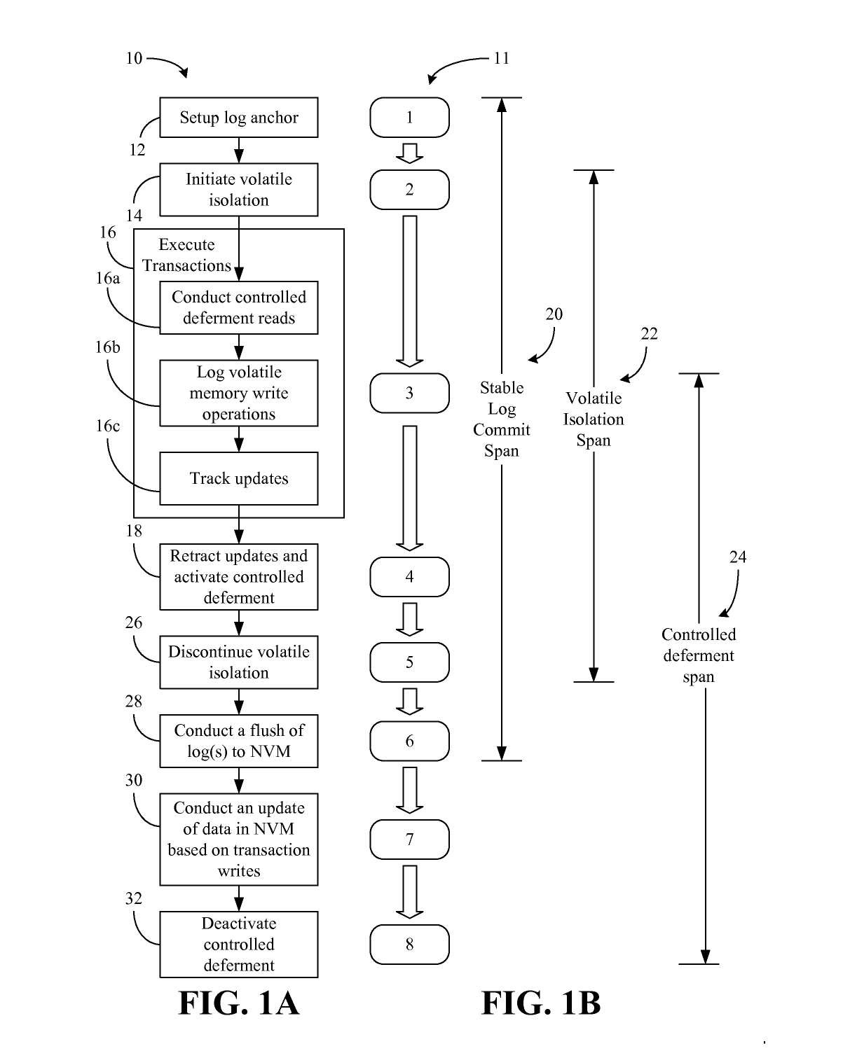

FIGS. 1A and 1B show a method 10 of operating a transaction synchronization apparatus and a corresponding set of sequence nodes 11 that model the method 10. The method 10 may generally be implemented in a data management system such as, for example, a database system, multithreaded object and file system, “big data” system, key-value store, and so forth. The transactions synchronized via the method 10 may generally conduct input/output (IO) operations, flush cache lines or otherwise write to NVM. As will be discussed in greater detail below, the method 10 may achieve relatively lightweight and fine-grained synchronization while optimizing load-store performance for durable data updated in-place (e.g., where the data is stored, rather than in a proxy or shadow location) in persistent memory.

The method 10 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 10 may be written in any combination of one or more programming languages, including an object oriented programming language such as C#, JAVA or the like.

Illustrated processing block 12 provides for setting up a log anchor. The log anchor may be associated with a storage location (e.g., address range) in non-volatile memory and block 12 may involve allocating the storage location to the anchor. Moreover, block 12 may represent the beginning of a stable log commit span 20 (e.g., defined by sequence nodes 1-6). Volatile isolation (e.g., Transactional Synchronization Extensions/TSX) may be initiated at block 14, wherein one or more transactions that involve modifications of variables in volatile memory via a cache (e.g., level one/L1 cache) may generally be executed at block 16 (16a-16c). Block 14 may represent the beginning of a volatile isolation span 22 (e.g., defined by sequence nodes 2-5). More particularly, execution of the transactions may include conducting one or more controlled deferment (e.g., “tripwired”) reads from the volatile memory at block 16a. The term “tripwire” may be used to indicate the controlled deferment of transactions without the use of locking, latching, functional composition, data decomposition or other overhead intensive techniques that may otherwise be used to achieve consistency and isolation (CI).

In one example, the activation of controlled deferment may include marking a location associated with a variable being modified by a given transaction. The marking may be achieved via hashing, bitmaps, range maps and/or other data structure set membership operations. In the case of hashing, the activation of controlled deferment may include initializing a hash value associated with the variable being modified by the given transaction, incrementing the hash value and storing the incremented hash value (e.g., to volatile memory). The hash value may be computed using a reasonably distributive hash function such as, for example, Knuth's multiplicative hash. Thus, the tripwire may be a lock-free signal to other transactions that self-deferment may be appropriate. Block 16a may therefore involve determining the hash value associated with the variable being read and deferring execution of the current transaction of the hash-value is non-zero. If, on the other hand, the hash value is zero, the current transaction may proceed.

Illustrated block 16b may generate a log of the transaction, wherein the log may record volatile memory writes. Block 16b may represent the beginning of a controlled deferment span 24 (e.g., defined by sequence nodes 3-8). Additionally, data updates corresponding to the logged transactions may be tracked at block 16c. The data updates may be the appropriate modifications to be made in the cache hierarchy due to the logged transactions. The data locations that are modified, as indicated by the transaction log created in block 16b, may be subject to tripwired accesses (i.e., for deferred updates) by any other transaction(s) until the tripwiring is removed, as described in greater detail below. Accordingly, those data locations are the locations being tracked in illustrated block 16c.

Block 18 may retract the updates and activate controlled deferment. As already noted, activating controlled deferment may include, for example, initializing a hash value associated with a variable being modified by a given transaction, incrementing the hash value and storing the incremented hash value to volatile memory. Other signals such as bitmaps, range maps, etc., may also be used to signal controlled deferment between transactions. For example, bitmaps might be used as an alternative to hashes, particularly if the locations being updated are closely clustered together in space, for efficiency—because a single bit may cover a block of locations with just a single tripwiring operation. Additionally, volatile isolation may be discontinued at block 26. Block 26 may represent the end of the volatile isolation span 22.

A flush of the logs to NVM is conducted at illustrated block 28, which represents the end of the stable log commit span 20. In response to completion of the flush of the logs, block 30 may conduct an update of data in NVM based on the variable modifications (e.g., writes) made by the transactions. Of particular note is that block 30 may occur during the controlled deferment span 24 (e.g., while controlled deferment is activated). Illustrated block 32 deactivates the controlled deferment. Accordingly, block 32 may represent the end of the controlled deferment span 24.

Thus, the illustrated method 10 provides log independence, data update deferral, tripwiring between logical and physical data updates, minimization of persistent memory commitment instructions and log ratcheting.

1. Log independence: Even though data is shared, the log that covers a transaction's updates may essentially be a private (per-thread or per-transaction) structure that is not protected. Thus, volatile isolation cover may not be necessary in order to flush the log. A global order among committed transaction logs may be sufficient, and the global order may be achievable without causing aborting of volatile isolations.

2. Deferring data updates: After a log flush covering a transaction's logical updates to data has completed, data updates may be completed (e.g., in NVM) in place, and in an arbitrary order, without being in jeopardy from machine failures, as logs may be used to recover any loss of data. Deferring updates in NVM beyond the moment of log flush without the benefit of transactional silos provided by volatile isolation may be achieved via tripwiring.

3. Tripwiring between logical (e.g., performed within volatile isolation region and not conveyed to NVM) and physical data updates (performed in place in NVM): Tripwiring may be used to defer log flushing until after volatile isolation cover while deferring data writes until after log flushes (since log flushing renders the updates stably recoverable). Such an approach may obviate concerns over races between writers and readers/writers. In tripwiring, a volatile byte array may be used to provide out-of-band signaling to trip up readers or writers that race with deferred writes. That is, data writes may be logically deferred until after the volatile isolation cover, but just-enough tripwiring may be used so that transactions that have actual data races over the deferred writes backout. Non-racing transactions, however, may continue as scheduled. Thus, tripwiring may achieve intertwining protection (e.g., three spans of protection interweave/overlap to provide a complete span that covers volatile isolation, logging, and data updates in NVM) that extends the logical span of a volatile isolation transaction without extending its physical (volatile isolation) span. Indeed, only a small amount of per-thread overhead may be encountered without sacrificing concurrency.

4. Minimization of persistent memory commitment instructions and exclusion duration: A key benefit of volatile isolation (e.g., INTEL® TSX) is that its logical (virtual) locking removes false contention that may otherwise result from actual (physical) locking. This benefit may be particularly significant when the duration of lock-based serialization (i.e., total lock hold time) becomes extended as described next. When transactions are in-place in NVM, the constraining factor (e.g., “long pole in the tent”) may be the time to commit updates to NVM. But as this disclosure shows, it is possible to collapse the duration of exclusion among racing transactions down to just a persistent memory commitment operation that fences the writing of logs into NVM due to the tripwiring technique, while non-racing transactions statistically avoid the tripwiring zones of one another altogether.

5. Log ratcheting: Additionally, recovery may be relatively fast, even though data updates in NVM may not be triggered. More particularly, to avoid having to go arbitrarily backwards to a very old consistency point, a system daemon may periodically set a global flag that stalls new log anchors, issue a persistent memory commitment instruction, wait for current open log buckets to close (i.e., current transactions to come to a barrier) and then reset the global flag. If this is done even as frequently as every few seconds (an “epoch”), the number of log buckets replayed on an uncontrolled restart may be reduced to just those that were in the last epoch.

One consequence of this type of log ratcheting is that the final persistent memory commitment instruction following the data write-outs (and cache line write-backs) may be bypassed (e.g., in sequence node 7). For example, a simple expedient may be used of going two epochs back in replaying completed log buckets due to the property that any persistent memory commitment-and-system-wide-barrier is equivalent to a system-wide-barrier in which every thread has performed its own persistent memory commitment instruction.

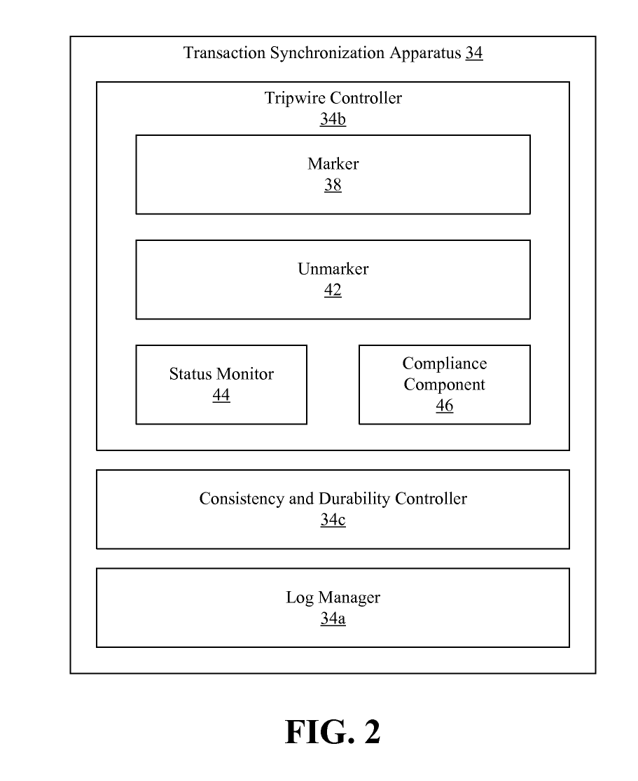

FIG. 2 shows a transaction synchronization apparatus 34. The apparatus 34 may generally implement one or more aspects of the method 10 (FIG. 1), already discussed. Thus, the apparatus 34 (34a-34c) may include logic instructions, configurable logic, fixed-functionality logic hardware, etc., or any combination thereof. In the illustrated example, a log manager 34a generates a log of a first transaction that involves a modification of a variable in volatile memory and a tripwire controller 34b activates a controlled deferment of a second transaction associated with the variable. Additionally, a coherency controller 34c may conduct an update (e.g., cache line writeback/CLWB) of data in non-volatile memory based on the modification while the controlled deferment is activated.

In one example, the tripwire controller 34b includes a marker 38 to mark a location (e.g., increment and store a hash value) associated with the variable to activate the controlled deferment. Moreover, the log manager 34a may conduct a flush of the log to the non-volatile memory, wherein the update is to be conducted in response to a completion of the flush. The tripwire controller 34b may deactivate the controlled deferment in response to a completion of the update. In this regard, the tripwire controller 34b may include an unmarker 42 to unmark the location (e.g., decrement and store the hash value) associated with the variable to deactivate the controlled deferment.

The illustrated tripwire controller 34b also includes a status monitor 44 to determine the hash value associated with the variable (e.g., in conjunction with a tripwire read). A transaction consistency and durability component 46 may defer execution of the first transaction if the hash value is non-zero.

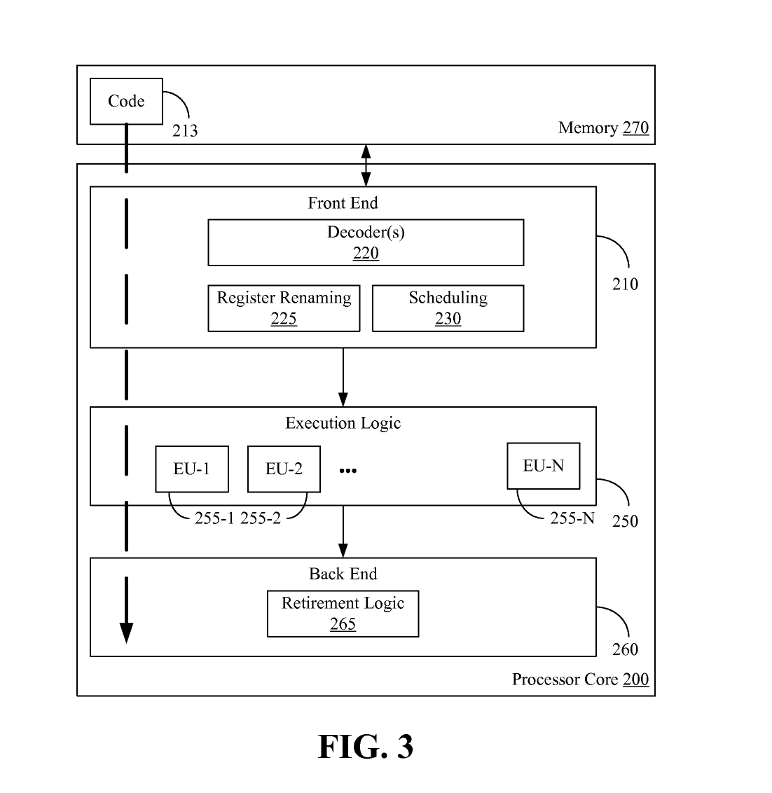

FIG. 3 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 3, a processing element may alternatively include more than one of the processor core 200 illustrated in FIG. 3. The processor core 200 may be a single-threaded core or, for at least one embodiment, the processor core 200 may be multithreaded in that it may include more than one hardware thread context (or “logical processor”) per core.

FIG. 3 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 10 (FIG. 1A), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 3, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

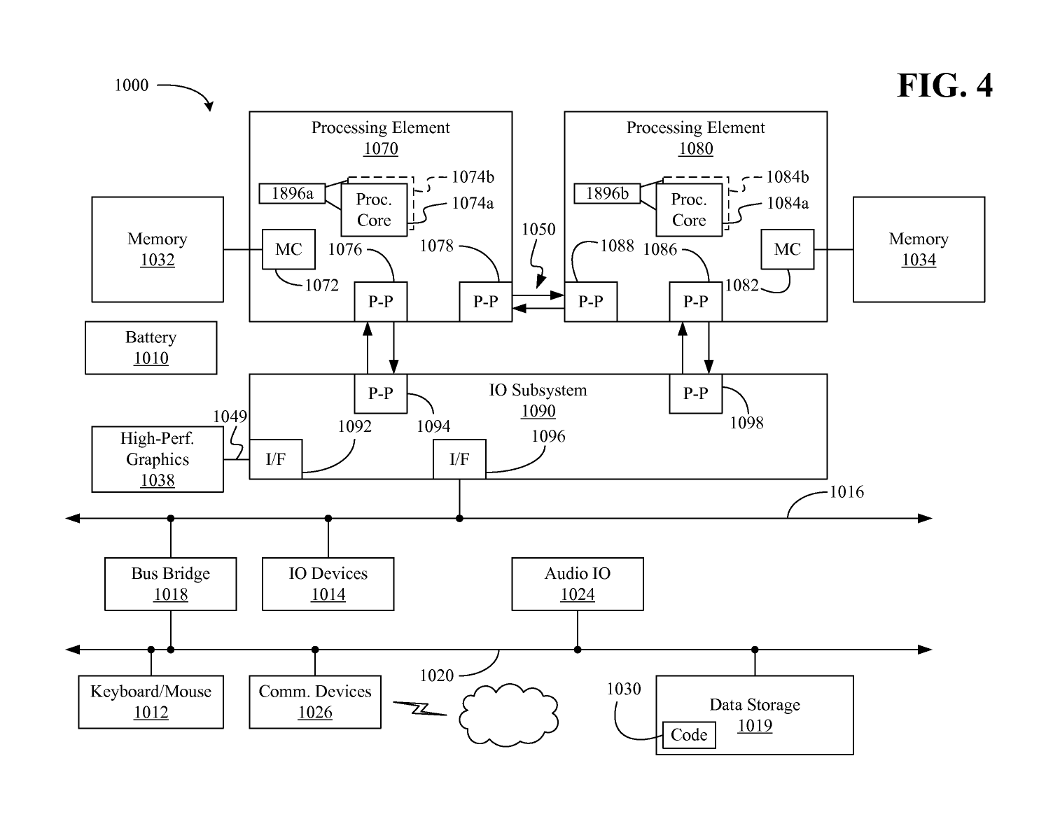

Referring now to FIG. 4, shown is a block diagram of a system 1000 embodiment in accordance with an embodiment. Shown in FIG. 4 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 4 may be implemented as a multi-drop bus rather than point-to-point interconnect.

As shown in FIG. 4, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 3.

Each processing element 1070, 1080 may include at least one shared cache 1896a, 1896b (e.g., static random access memory/SRAM). The shared cache 1896a, 1896b may store data (e.g., objects, instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 4, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 4, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 4, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the method 10 (FIG. 1A), already discussed, and may be similar to the code 213 (FIG. 3), already discussed. The system 1000 may also include a transaction synchronization apparatus such as, for example, the transaction synchronization apparatus 34 (FIG. 2). Further, an audio I/O 1024 may be coupled to second bus 1020.

Note that other embodiments are contemplated. For example, instead of the point-to-point architecture of FIG. 4, a system may implement a multi-drop bus or another such communication topology. Also, the elements of FIG. 4 may alternatively be partitioned using more or fewer integrated chips than shown in FIG. 4. Moreover, the network controllers/communication device(s) 1026 may be implemented as a HFI (host fabric interface), also known as NIC (network interface card), that is integrated with one or more of the processing elements 1070, 1080 either on the same die, or in the same package.

### ADDITIONAL NOTES AND EXAMPLES

Example 1 may include a data management system comprising a volatile memory, a non-volatile memory, and a transaction synchronization apparatus including a log manager to generate a log of a first transaction that involves a modification of a variable in the volatile memory, a tripwire controller to activate a controlled deferment of a second transaction associated with the variable, and a consistency and durability controller to conduct an update of data in the non-volatile memory based on the modification while the controlled deferment is activated.

Example 2 may include the system of Example 1, wherein the tripwire controller includes a marker to mark a location associated with the variable.

Example 3 may include the system of Example 1, wherein the log manager is to conduct a flush of the log to the non-volatile memory, and wherein the update is to be conducted in response to a completion of the flush.

Example 4 may include the system of any one of Examples 1 to 3, wherein the tripwire controller is to deactivate the controlled deferment in response to a completion of the update.

Example 5 may include the system of Example 4, wherein the tripwire controller includes an unmarker to unmark a location associated with the variable.

Example 6 may include the system of Example 1, wherein the tripwire controller includes a status monitor to detect an access to a location associated with the variable, and a compliance component to defer execution of the first transaction in response to the access.

Example 7 may include a transaction synchronization apparatus comprising a log manager to generate a log of a first transaction that involves a modification of a variable in a volatile memory, a tripwire controller to activate a controlled deferment of a second transaction associated with the variable, and a consistency and durability controller to conduct an update of data in non-volatile memory based on the modification while the controlled deferment is activated.

Example 8 may include the apparatus of Example 7, wherein the tripwire controller includes a marker to mark a location associated with the variable.

Example 9 may include the apparatus of Example 7, wherein the log manager is to conduct a flush of the log to the non-volatile memory, and wherein the update is to be conducted in response to a completion of the flush.

Example 10 may include the apparatus of any one of Examples 7 to 9, wherein the tripwire controller is to deactivate the controlled deferment in response to a completion of the update.

Example 11 may include the apparatus of Example 10, wherein the tripwire controller includes an unmarker to unmark a location associated with the variable.

Example 12 may include the apparatus of Example 7, wherein the tripwire controller includes a status monitor to detect an access to a location associated with the variable, and a compliance component to defer execution of the first transaction in response to the access.

Example 13 may include a method of operating a transaction synchronization apparatus, comprising generating a log of a first transaction that involves a modification of a variable in a volatile memory, activating a controlled deferment of a second transaction associated with the variable, and conducting an update of data in non-volatile memory based on the modification while the controlled deferment is activated.

Example 14 may include the method of Example 13, wherein activating the controlled deferment includes marking a location associated with the variable.

Example 15 may include the method of Example 13, further including conducting a flush of the log to the non-volatile memory, wherein the update is conducted in response to a completion of the flush.

Example 16 may include the method of any one of Examples 13 to 15, further including deactivating the controlled deferment in response to a completion of the update.

Example 17 may include the method of Example 16, wherein deactivating the controlled deferment includes unmarking a location associated with the variable.

Example 18 may include the method of Example 13, further including detecting an access to a location associated with the variable, and deferring execution of the first transaction in response to the access.

Example 19 may include at least one non-transitory computer readable storage medium comprising a set of instructions, which when executed by a computing device, cause the computing device to generate a log of a first transaction that involves a modification of a variable in a volatile memory, activate a controlled deferment of a second transaction associated with the variable, and conduct an update of data in non-volatile memory based on the modification while the controlled deferment is activated.

Example 20 may include the at least one non-transitory computer readable storage medium of Example 19, wherein the instructions, when executed, cause a computing device to mark a location associated with the variable.

Example 21 may include the at least one non-transitory computer readable storage medium of Example 19, wherein the instructions, when executed, cause a computing device to conduct a flush of the log to the non-volatile memory, and wherein the update is to be conducted in response to a completion of the flush.

Example 22 may include the at least one non-transitory computer readable storage medium of any one of Examples 19 to 21, wherein the instructions, when executed, cause a computing device to deactivate the controlled deferment in response to a completion of the update.

Example 23 may include the at least one non-transitory computer readable storage medium of Example 22, wherein the instructions, when executed, cause a computing device to unmarking a location associated with the variable.

Example 24 may include the at least one non-transitory computer readable storage medium of Example 19, wherein the instructions, when executed, cause a computing device to detecting an access to a location associated with the variable, and defer execution of the first transaction in response to the access.

Example 25 may include a transaction synchronization apparatus comprising means for generating a log of a first transaction that involves a modification of a variable in a volatile memory, means for activating a controlled deferment of a second transaction associated with the variable, and means for conducting an update of data in non-volatile memory based on the modification while the controlled deferment is activated.

Example 26 may include the apparatus of Example 25, wherein the means for activating the controlled deferment includes means for marking a location associated with the variable.

Example 27 may include the apparatus of Example 25, further including means for conducting a flush of the log to the non-volatile memory, wherein the update is to be conducted in response to a completion of the flush.

Example 28 may include the apparatus of any one of Examples 25 to 27 further including means for deactivating the controlled deferment in response to a completion of the update.

Example 29 may include the apparatus of Example 28, wherein the means for deactivating the controlled deferment includes means for unmarking a location associated with the variable.

Example 30 may include the apparatus of Example 25, further including means for detecting an access to a location associated with the variable, and means for deferring execution of the first transaction in response to the access.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a volatile memory;
a non-volatile memory; and
a transaction synchronization apparatus including,
a log manager to generate a log of a first transaction that involves a modification of a variable in the volatile memory,
a tripwire controller to activate a controlled deferment of a second transaction associated with the variable, and
a consistency and durability controller to conduct an update of data in the non-volatile memory based on the modification while the controlled deferment is activated.

2. The system of claim 1, wherein the tripwire controller includes a marker to mark a location associated with the variable

3. The system of claim 1, wherein the log manager is to conduct a flush of the log to the non-volatile memory, and wherein the update is to be conducted in response to a completion of the flush.

4. The system of claim 1, wherein the tripwire controller is to deactivate the controlled deferment in response to a completion of the update.

5. The system of claim 4, wherein the tripwire controller includes an unmarker to unmark a location associated with the variable.

6. The system of claim 1, wherein the tripwire controller includes:
a status monitor to determine a hash value associated with the variable; and
a compliance component to defer execution of the first transaction if the hash value is non-zero.

7. An apparatus comprising:
a log manager to generate a log of a first transaction that involves a modification of a variable in a volatile memory;
a tripwire controller to activate a controlled deferment of a second transaction associated with the variable; and
a consistency and durability controller to conduct an update of data in non-volatile memory based on the modification while the controlled deferment is activated.

8. The apparatus of claim 7, wherein the tripwire controller includes a marker to mark a location associated with the variable.

9. The apparatus of claim 7, wherein the log manager is to conduct a flush of the log to the non-volatile memory, and wherein the update is to be conducted in response to a completion of the flush.

10. The apparatus of claim 7, wherein the tripwire controller is to deactivate the controlled deferment in response to a completion of the update.

11. The apparatus of claim 10, wherein the tripwire controller includes an unmarker to unmark a location associated with the variable.

12. The apparatus of claim 7, wherein the tripwire controller includes:
a status monitor to determine a hash value associated with the variable; and
a compliance component to defer execution of the first transaction if the hash value is non-zero.

13. A method comprising:
generating a log of a first transaction that involves a modification of a variable in a volatile memory;
activating a controlled deferment of a second transaction associated with the variable; and
conducting an update of data in non-volatile memory based on the modification while the controlled deferment is activated.

14. The method of claim 13, wherein activating the controlled deferment includes marking a location associated with the variable.

15. The method of claim 13, further including conducting a flush of the log to the non-volatile memory, wherein the update is conducted in response to a completion of the flush.

16. The method of claim 13, further including deactivating the controlled deferment in response to a completion of the update.

17. The method of claim 16, wherein deactivating the controlled deferment includes unmarking a location associated with the variable.

18. The method of claim 13, further including:
determining a hash value associated with the variable; and
deferring execution of the first transaction if the hash value is non-zero.

19. At least one non-transitory computer readable storage medium comprising a set of instructions, which when executed by a computing device, cause the computing device to:
generate a log of a first transaction that involves a modification of a variable in a volatile memory;
activate a controlled deferment of a second transaction associated with the variable; and
conduct an update of data in non-volatile memory based on the modification while the controlled deferment is activated.

20. The at least one non-transitory computer readable storage medium of claim 19, wherein the instructions, when executed, cause a computing device to mark a location associated with the variable.

21. The at least one non-transitory computer readable storage medium of claim 19, wherein the instructions, when executed, cause a computing device to conduct a flush of the log to the non-volatile memory, and wherein the update is to be conducted in response to a completion of the flush.

22. The at least one non-transitory computer readable storage medium of claim 19, wherein the instructions, when executed, cause a computing device to deactivate the controlled deferment in response to a completion of the update.

23. The at least one non-transitory computer readable storage medium of claim 22, wherein the instructions, when executed, cause a computing device to unmarking a location associated with the variable.

24. The at least one non-transitory computer readable storage medium of claim 19, wherein the instructions, when executed, cause a computing device to:
detecting an access to a location associated with the variable; and
defer execution of the first transaction in response to the access.
